(19) United States
(12) Patent Application Publication
(10) Pub. No.: US 2026/0288075 A1
(43) Pub. Date: Sep. 24, 2026

(54) TIMEPIECE, MODULE, AND METHOD FOR MANUFACTURING TIMEPIECE

(71) Applicant: CASIO COMPUTER CO., LTD., Tokyo (JP)

(72) Inventor: Jun MIWA, Tokyo (JP)

(73) Assignee: CASIO COMPUTER CO., LTD., Tokyo (JP)

(21) Appl. No.: 19/566,730

(22) Filed: Mar. 13, 2026

(30) Foreign Application Priority Data
Mar. 18, 2025 (JP) 2025-043137

(51) Int. Cl. G04C 3/00

(52) U.S. Cl. CPC G04C 3/008

(57) ABSTRACT

A timepiece includes: a first plate-shaped member formed of a conductive material; a second plate-shaped member disposed on a first side of the first plate-shaped member and formed of a conductive material; a circuit board disposed between the first plate-shaped member and the second plate-shaped member; and a connecting member that electrically connects the first plate-shaped member to the second plate-shaped member. A through hole is formed in the circuit board, and the connecting member is inserted in the through hole to electrically connect the first plate-shaped member to the second plate-shaped member.

### CROSS-REFERENCE TO RELATED APPLICATION

This application is based upon and claims the benefit of priority from the prior Japanese Patent Application 2025-043137, filed on Mar. 18, 2025, the entire contents of which are incorporated herein by reference.

### BACKGROUND OF THE INVENTION

### Technical Field

The present invention relates to a timepiece, a module, and a method for manufacturing a timepiece.

### Description of Related Art

It is known that internal equipment can be damaged by static electricity entering from the outside, as described in JP 2000-292567A, and countermeasures are required. In this regard, a method is known that uses connecting members such as coil springs to establish electrical continuity between metal components. Therefore, a structure can be conceived where a metal component charged with static electricity entering from the outside is electrically connected to a metal component serving as the GND by using a coil spring or the like, thereby discharging the static electricity to the GND.

### SUMMARY OF THE INVENTION

A timepiece reflecting one aspect of the present invention comprises: a first plate-shaped member formed of a conductive material; a second plate-shaped member disposed on a first side of the first plate-shaped member and formed of a conductive material; a circuit board disposed between the first plate-shaped member and the second plate-shaped member; and a connecting member that electrically connects the first plate-shaped member to the second plate-shaped member, wherein a through hole is formed in the circuit board, and the connecting member is inserted in the through hole to electrically connect the first plate-shaped member to the second plate-shaped member.

### BRIEF DESCRIPTION OF DRAWINGS

The accompanying drawings are not intended as a definition of the limits of the invention but illustrate embodiments of the invention, and, together with the general description given above and the detailed description of the embodiments given below, serve to explain the principles of the invention, wherein:

FIG. 1 is a perspective view of a major portion of a module provided in a timepiece according to embodiments, as seen from the back surface side;

FIG. 2 is a cross-sectional view of a major portion of an internal structure of a timepiece according to a first embodiment;

FIG. 3 is a schematic side view of a circuit retainer;

FIG. 4 is a schematic plan view of the circuit retainer as seen from the front surface side;

FIG. 5 is an enlarged cross-sectional view of a region around a coil spring illustrated in FIG. 2;

FIG. 6 is a cross-sectional view of a major portion of an internal structure of a timepiece according to a second embodiment;

FIG. 7 is a cross-sectional view of a major portion of an internal structure of a timepiece according to a third embodiment; and

FIG. 8 is a cross-sectional view of a major portion showing an example of an internal structure of a conventional timepiece.

### DETAILED DESCRIPTION

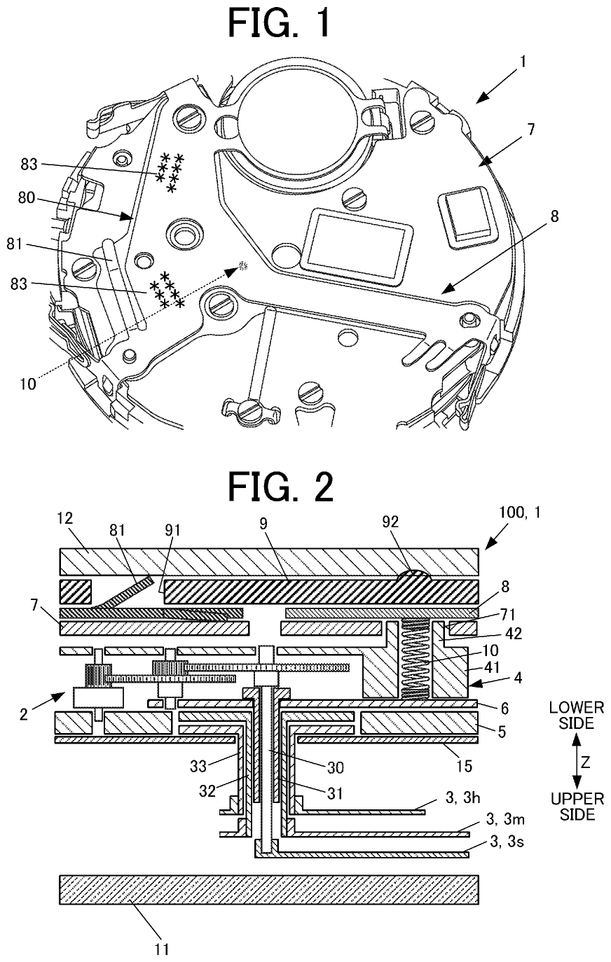

Hereinafter, embodiments of the present invention will be described with reference to the drawings. In the following description and in FIG. 2 and the like, the thickness direction (top-bottom direction) of a timepiece 100 is defined as the Z-direction. In the Z-direction, the front side of the timepiece 100, which is the visible side, is referred to as the “upper side (front surface side)”, and the back side of the timepiece 100 is referred to as the “lower side (back surface side)”. FIG. 1 illustrates a state where a buffer plate 9 has been removed from a module 1, exposing a circuit board 7 and a circuit retainer 8. Furthermore, the cross-sectional views illustrated in FIG. 2 and the like are schematic diagrams for explaining the configuration and do not accurately depict the position or shape of each component. Although the embodiments described below include various technically desirable limitations for implementing the present invention, the scope of the present invention is not limited to the following embodiments or illustrated examples.

Several embodiments of the present invention will be described below. Many of the components, the layered structures of the components, and the like of the module 1 provided in the timepiece 100 are common across the embodiments. Therefore, the portions common to all of the embodiments will be described first.

The timepiece 100 according to the embodiments is an analog timepiece that displays time by having a plurality of hands 3 point to unillustrated hour markers. In the illustrated examples, there are three hands: a second hand 3s, a minute hand 3m, and an hour hand 3h. The number of hands provided on the timepiece 100 is not limited to three. For example, the timepiece 100 may have only two hands, such as the minute hand 3m and the hour hand 3h, or the timepiece 100 may have various functional hands in addition to the three hands of the second hand 3s, the minute hand 3m, and the hour hand 3h. The timepiece 100 includes the module 1 that is substantially disc-shaped, as illustrated in FIG. 1. Although not shown, the module 1 is housed in a case that is open on the upper and lower sides in the Z-direction. The opening of the case on the upper side in the Z-direction (the visible side, or front surface side, of the timepiece) is closed with a watch glass 11, which is a transparent member (cover member) formed of glass or a transparent resin. Furthermore, a back cover 12 is provided on the bottom side of the case (the lower side in the Z-direction, the back surface side of the timepiece 100) to close the opening on the back surface side (see FIG. 2).

The module 1 includes a plurality of drive mechanisms that individually rotate and drive the plurality of hands 3. Each drive mechanism includes a motor (not shown) as the drive source and a gear train mechanism that transmits the motor's driving force to each hand 3. Each gear train mechanism includes a plurality of gear assemblies (gears and shafts). For example, the gear train mechanism for the second hand drive mechanism includes gear assemblies such as a fourth wheel and pinion (seconds wheel and pinion). The gear train mechanism for the minute hand drive mechanism includes gear assemblies such as a center wheel and pinion. The gear train mechanism for the hour hand drive mechanism includes gear assemblies such as a minute wheel and an hour wheel. Note that the gear train mechanism may include gearwheels other than the gear assemblies. The gear and shaft may be separate components, provided that the gear and shaft are integrally combined. In the embodiments, a drive mechanism unit (a predetermined mechanism structure in these embodiments) that includes the motors and gear assemblies is collectively referred to as an “analog block 2”. As illustrated in FIG. 2, the analog block 2 is disposed on the upper side of the circuit board 7 (the upper side in the Z-direction), which is described below.

Static electricity enters the interior of the timepiece 100 from the outside. For example, static electricity first enters via a hand shaft 30 (shaft). The hand shaft 30 is a shaft component made of, for example, carbon tool steel (SK material) and is disposed along the Z-direction (the top-bottom direction of the timepiece). The hand shaft 30 is rotatably supported around its central axis by components such as a train bridge 4. The second hand 3s is fixed to the free end side of the hand shaft 30 (the upper side in the Z-direction). The train bridge 4 is disposed on the lower side (the lower side in the Z-direction) of a main plate 5 and supports the lower end of the hand shaft 30. Without any static electricity countermeasures, static electricity entering via the hand shaft 30 can flow through internal components to the circuit board 7. The circuit board 7 carries precision electronic components such as a large-scale integration (LSI) circuit (not shown), and static electricity flowing to the circuit board 7 can damage these components.

As illustrated in FIG. 2, approximately the lower half of the hand shaft 30, excluding the lower end, is inserted in a tubular member 31. The tubular member 31 is a substantially cylindrical component and is a conductive component formed of a metal material such as stainless steel. The base end (the lower side in the Z-direction) of the tubular member 31 is fixed to a center wheel bridge 6 by press-fitting or similar means. The center wheel bridge 6 is formed of a metal material such as stainless steel and, in the embodiments, is a second plate-shaped member formed of a conductive material. The center wheel bridge 6 is disposed between the main plate 5 and the train bridge 4. While the center wheel bridge 6 does not directly contact the hand shaft 30, the center wheel bridge 6 supports a portion of the hand shaft 30 in the top-bottom direction (Z-direction) via the conductive tubular member 31. As a result, the center wheel bridge 6 is electrically connected to the hand shaft 30 via the tubular member 31, and static electricity entering via the hand shaft 30 flows into the center wheel bridge 6.

To prevent external static electricity from flowing to the circuit board 7, the center wheel bridge 6 is disposed in an electrically floating state with respect to the GND potential. In the embodiments described below, the static electricity flowing into the center wheel bridge 6 is discharged to a first plate-shaped member that has the GND potential and is formed of a conductive material. The first plate-shaped member having the GND potential is the circuit retainer 8 (in first and second embodiments) or the back cover 12 (in a third embodiment).

Furthermore, a center wheel and pinion 32 (a tubular portion of the center wheel and pinion), which constitutes the gear train mechanism for the minute hand drive mechanism, is coaxially disposed on the outer side of the tubular member 31. Further, a cylindrical hour wheel 33, which constitutes the gear train mechanism for the hour hand drive mechanism, is coaxially disposed on the outer side of the tubular portion of the center wheel and pinion 32. The minute hand 3m is fixed to the free end side (the upper side in the Z-direction) of the tubular portion of the center wheel and pinion 32. The hour hand 3h is fixed to the free end side (the upper side in the Z-direction) of the hour wheel 33.

As illustrated in FIG. 2, a plate-shaped member 15 for display is disposed on the upper side (the upper side in the Z-direction) of the main plate 5. The plate-shaped member 15 for display includes, for example, a dial and a date dial guard. In the Z-direction layered configuration of the timepiece 100 according to the embodiments, viewed from the watch glass 11 to the back cover 12, the plate-shaped member 15 for display is disposed on the lower side of the watch glass 11. The main plate 5 is disposed on the lower side of the plate-shaped member 15 for display, and the center wheel bridge 6 is disposed on the lower side of the main plate 5. On the lower side of the center wheel bridge 6 is the train bridge 4. On the lower side of the train bridge 4 is the circuit board 7. On the lower side of the circuit board 7 is the circuit retainer 8. On the lower side of the circuit retainer 8, the back cover 12 is disposed via the buffer plate 9. Note that the members from the plate-shaped member 15 for display to the buffer plate 9 do not overlap at all points in the in-plane direction. Instead, they overlap overall while appropriately avoiding components to be mounted and the like by holes or notches.

The main plate 5 and train bridge 4 are plate-shaped members formed, for example, of resin. In the embodiments, the train bridge 4 is a third plate-shaped member formed of a non-conductive material, disposed between the center wheel bridge 6, which is the second plate-shaped member, and the circuit board 7. Furthermore, the main plate 5 is a fourth plate-shaped member disposed on the opposite side of the center wheel bridge 6, which is the second plate-shaped member, from the side facing the circuit board 7. As described above, the circuit board 7 is disposed between the circuit retainer 8, which is the first plate-shaped member, and the center wheel bridge 6, which is the second plate-shaped member. Although not shown, various electronic components are mounted on the circuit board 7 as appropriate. Furthermore, the circuit board 7 according to the embodiments has a through hole 71 that runs through the circuit board 7 in the thickness direction. A connecting member that electrically connects the circuit retainer 8, which is the first plate-shaped member, to the center wheel bridge 6, which is the second plate-shaped member, is disposed within this through hole 71. In the embodiments, the connecting member is a coil spring 10. Note that the connecting member may be any element capable of electrically connecting the first plate-shaped member to the second plate-shaped member and is not limited to a coil spring.

The buffer plate 9 is formed of a resin or the like having a buffering effect and is an elastic plate-shaped member layered on the back surface side (opposite a first side) of the circuit retainer 8, which is the lower side in the Z-direction. The buffer plate 9 presses the entire circuit retainer 8, which is disposed on the visible side relative to the buffer plate 9, in a substantially uniform manner and has the effect of absorbing external impacts. As illustrated in FIG. 2, the buffer plate 9 according to the embodiments has protrusions 92 suitably provided on the surface facing the back cover 12. The number and arrangement of the protrusions 92 are not particularly limited, but it is preferable that the protrusions 92 are provided at least in a region corresponding to the location where the coil spring 10 described later is disposed. This effectively restrains the coil spring 10 that attempts to push up in the Z-direction, enabling the coil spring 10 to reliably connect (electrically connect) the center wheel bridge 6 to the circuit retainer 8. Although, in the embodiments, the case where the protrusions 92 are formed on the surface of the lower side in the Z-direction (the side facing the back cover 12) has been illustrated, the protrusions 92 may also be provided on the opposite surface of the buffer plate 9 (the surface of the upper side in the Z-direction). Furthermore, an opening 91 that extends through the buffer plate 9 is formed in a portion of the buffer plate 9. A contact tongue 81 of the circuit retainer 8 is exposed toward the back cover 12 through the opening 91.

The circuit retainer 8 is formed of a conductive material and functions as the first plate-shaped member in both the first and second embodiments. As illustrated in FIG. 1, a main body 80 of the circuit retainer 8 is fixed to the circuit board 7 disposed on the upper side in the Z-direction. Note that the upper side of the circuit retainer 8 in the Z-direction (the front surface side of the timepiece 100, the side facing the circuit board 7) is defined as the first side. The center wheel bridge 6, which is the second plate-shaped member, is disposed (layered) on the first side (front surface side) of the circuit retainer 8. The circuit retainer 8 has the contact tongue 81 that is electrically connected to the back cover 12, which functions as the GND. The contact tongue 81 rises from the main body 80 on the back surface side opposite the first side and is exposed toward the back cover 12 through the opening 91 in the buffer plate 9. Contact between the contact tongue 81 and the back cover 12 provides the circuit retainer 8 with the GND potential.

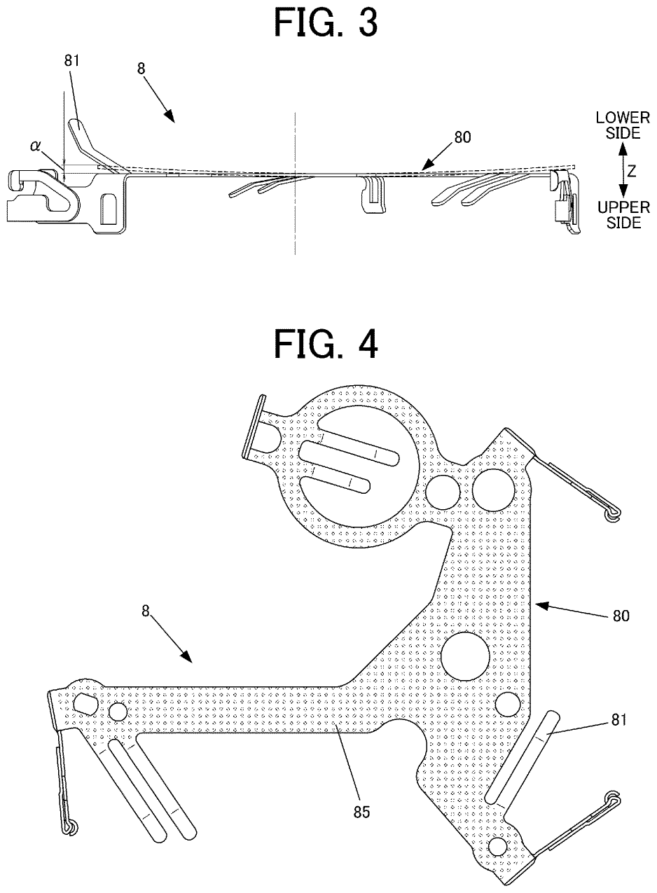

As illustrated in FIG. 1, in the embodiments, the main body 80 of the circuit retainer 8 has an engraved portion 83 on the surface of the back surface side, which is the side facing the back cover 12 and is the lower side in the Z-direction. Engraved marks such as various logos are engraved in the engraved portion 83. As illustrated in the side view of FIG. 3, the circuit retainer 8 is a relatively thin metal plate or the like. When engraving processing is applied to one surface, the circuit retainer 8 has the property of warping toward the side facing the surface on which the engraving is applied. FIG. 3 illustrates the circuit retainer 8 warping by a warping amount α. When the circuit retainer 8 warps toward the side facing the surface on which the engraving is applied (the back surface side, which is opposite the first side in the embodiments), there is a risk that the coil spring 10 cannot reliably contact the circuit retainer 8. Therefore, in the embodiments, a stippling finish is applied on the surface of the first side of the circuit retainer 8, opposite the side where the engraved portion 83 is formed, to form a stippled portion 85 (see FIG. 4). This allows the warping induced in the circuit retainer 8 by forming the engraved portion 83 to be counteracted by the warping on the opposite side, thereby enhancing the connectivity between the coil spring 10 and the circuit retainer 8.

Next, each embodiment will be described in detail. First, in the timepiece 100 according to the first embodiment including the module 1, the first plate-shaped member is the circuit retainer 8. The first plate-shaped member is electrically connected to the center wheel bridge 6, which is the second plate-shaped member, by the coil spring 10 as the connecting member. In this case, the length of the coil spring 10 in the Z-direction is set slightly longer than the distance from the center wheel bridge 6 to the circuit retainer 8 in the Z-direction, enabling the coil spring 10 to reliably contact the center wheel bridge 6 and the circuit retainer 8. As illustrated in FIG. 2, the train bridge 4 and the circuit board 7, which are interposed between the circuit retainer 8 as the first plate-shaped member and the center wheel bridge 6 as the second plate-shaped member, each have a through hole in which the coil spring 10 is inserted in the Z-direction.

Specifically, as described above, the through hole 71 is formed in the circuit board 7. Furthermore, in the train bridge 4 as the third plate-shaped member, a tubular support portion 41 is erected along the penetration direction of the through hole 71 at a position corresponding to the through hole 71 in the circuit board 7. The tubular support portion 41 is a tubular portion that supports the coil spring 10, which is the connecting member, therein. The coil spring 10 and at least a portion of the tubular support portion 41 supporting the coil spring 10 are inserted in the through hole 71 in the circuit board 7. In the embodiment, the tubular support portion 41 is a support structure provided between the circuit retainer 8 as the first plate-shaped member and the center wheel bridge 6 as the second plate-shaped member. The tubular support portion 41 as the support structure supports the coil spring 10 as the connecting member in an upright state and maintains that upright state. In the example illustrated in FIG. 2, the tubular support portion 41 is formed both on the front and back surface sides of the train bridge 4. The tubular support portion 41 has a smaller-diameter portion 42 on the lower side (the back surface side) of the train bridge 4 in the Z-direction with a smaller diameter compared to the upper side (the front surface side). The through hole 71 has a diameter that allows insertion of at least the smaller-diameter portion 42 of the tubular support portion 41 of the train bridge 4. The coil spring 10 and the smaller-diameter portion 42 are inserted in the through hole 71.

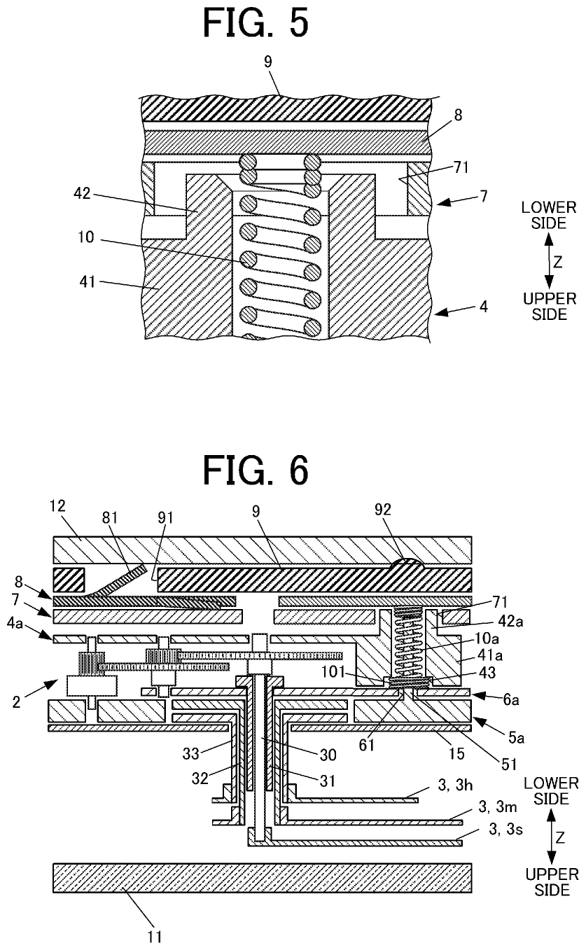

The coil spring 10 is disposed within the tubular support portion 41, and one end of the coil spring 10 contacts the center wheel bridge 6, which is disposed on the upper side of the train bridge 4 in the Z-direction. Furthermore, the Z-direction length of the coil spring 10 is longer than the Z-direction length of the tubular support portion 41, and the other end of the coil spring 10 protrudes from the end (the end on the lower side in the Z-direction) of the tubular support portion 41 (smaller-diameter portion 42). When the circuit retainer 8 is disposed on the Z-direction lower side of both the train bridge 4 and the circuit board 7, the other end of the coil spring 10, in its inserted state within the tubular support portion 41, contacts the circuit retainer 8 on the front surface side (first side) (see FIG. 5). This electrically connects the center wheel bridge 6 to the circuit retainer 8 via the coil spring 10. In FIG. 1, the coil spring 10, which contacts the circuit retainer 8 on the front surface side (first side) and does not appear on the back surface side of the module 1, is shown with a dashed line. However, FIG. 1 is merely a schematic diagram and does not accurately indicate the position where the coil spring 10 is provided as the connecting member. Furthermore, in the embodiment, the position of the electrical connection between the circuit retainer 8 (first plate-shaped member) and the center wheel bridge 6 (second plate-shaped member) via the coil spring 10 is merely one example and is not limited to the illustrated examples.

Next, a method for manufacturing the timepiece 100 is described, focusing on the assembly of the module 1. In the first embodiment, when assembling the module 1, the train bridge 4 is disposed on the Z-direction lower side of the center wheel bridge 6, and the circuit board 7 is disposed on the Z-direction lower side of the train bridge 4. In this step, the tubular support portion 41 (the smaller-diameter portion 42 of the tubular support portion 41) of the train bridge 4 is inserted into the through hole 71 in the circuit board 7. Then, with the tubular support portion 41 of the train bridge 4 exposed from the through hole 71 in the circuit board 7 toward the Z-direction lower side, the coil spring 10 is disposed within the through hole 71 and the tubular support portion 41. The circuit retainer 8 is disposed on the Z-direction lower side of the circuit board 7. As illustrated in FIG. 5, with this arrangement, the circuit retainer 8 blocks the through hole 71 and the tubular support portion 41 within both of which the coil spring 10 is disposed. Furthermore, this circuit retainer 8 is pressed toward the upper side in the Z-direction by the buffer plate 9 in a substantially uniform manner. In particular, in the embodiment, a protrusion 92 is provided at least in a region of the buffer plate 9 corresponding to the coil spring 10. This ensures that the coil spring 10 is reliably pressed in the Z-direction. Consequently, the coil spring 10 stably contacts both the center wheel bridge 6 and the circuit retainer 8, allowing static electricity flowing from the hand shaft 30 to the center wheel bridge 6 to be discharged to the circuit retainer 8. Furthermore, the static electricity flowing from the center wheel bridge 6 to the circuit retainer 8 via the coil spring 10 is further discharged to the back cover 12 via the contact tongue 81 of the circuit retainer 8. In the embodiment, even when the back cover 12, circuit retainer 8, and buffer plate 9 are removed during repairs or other operations, the coil spring 10 does not accidentally fall out to the Z-direction upper side beyond the circuit board 7. This prevents the coil spring 10 from becoming mixed into the analog block 2, which is the predetermined mechanism structure in the embodiment.

Next, in a timepiece according to the second embodiment, as in the first embodiment, a through hole 71 is provided in a circuit board 7 that is interposed between a circuit retainer 8 as the first plate-shaped member and a center wheel bridge 6a as the second plate-shaped member. In addition, a train bridge 4a is provided with a tubular support portion 41a. At least a portion of the tubular support portion 41a (a smaller-diameter portion 42a in FIG. 6) is inserted in the through hole 71. Furthermore, a coil spring 10a according to the second embodiment is a stepped coil spring. One end of the coil spring 10a (an end portion on the side contacting the center wheel bridge 6a as the second plate-shaped member) has a flange 101 serving as an outward flange for locking with a larger diameter than the spring body. A recess 43 is formed in the tubular support portion 41a of the train bridge 4a as a step portion to lock the flange 101. In the assembled state of this embodiment, the flange 101 is disposed within the recess 43 of the train bridge 4a. This prevents the coil spring 10a from slipping out of the train bridge 4a.

Furthermore, on the surface of the Z-direction lower side of the main plate 5a, which is the fourth plate-shaped member, a guide shaft portion 51 protruding toward the lower side in the Z-direction is erected, corresponding to the position where the coil spring 10a as the connecting member is disposed. The guide shaft portion 51 is a boss inserted in the coil spring 10a along the penetration direction of the through hole 71. In the embodiment, the tubular support portion 41a and guide shaft portion 51 constitute a support structure provided between the circuit retainer 8 as the first plate-shaped member and the center wheel bridge 6a as the second plate-shaped member. The tubular support portion 41a and the guide shaft portion 51 as the support structure support the coil spring 10a as the connecting member in an upright state and maintain that upright state. In the embodiment, a through hole 61 (second through hole) is formed in the center wheel bridge 6a as the second plate-shaped member at a position corresponding to this guide shaft portion 51. The guide shaft portion 51 is inserted in the through hole 61 from the upper side to the lower side in the Z-direction. Other configurations are the same as in the first embodiment. Therefore, the same reference numerals are used for corresponding components, and descriptions thereof are omitted.

In the second embodiment, when assembling the module 1, the center wheel bridge 6a is disposed on the Z-direction lower side of the main plate 5a. In this step, the guide shaft portion 51 is inserted into the through hole 61. Then, the guide shaft portion 51 is inserted into the coil spring 10a with the flange 101 facing the center wheel bridge 6a. Subsequently, the train bridge 4a is layered on the Z-direction lower side of the center wheel bridge 6a. In this step, the guide shaft portion 51 and the coil spring 10a are inserted into the tubular support portion 41a. Also, the flange 101 of the coil spring 10a is disposed within the recess 43. Furthermore, the circuit board 7 is disposed on the Z-direction lower side of the train bridge 4a. In this step, the tubular support portion 41a with the guide shaft portion 51 and coil spring 10a inserted is inserted into the through hole 71. The coil spring 10a protrudes toward the Z-direction lower side beyond both the tubular support portion 41a (the smaller-diameter portion 42a of the tubular support portion 41a) and the through hole 71. When the circuit retainer 8 is disposed on the Z-direction lower side of both the train bridge 4a and the circuit board 7, the other end of the coil spring 10a, in its inserted state within the tubular support portion 41a, contacts the circuit retainer 8 on the front surface side (first side). This electrically connects the center wheel bridge 6a to the circuit retainer 8 via the coil spring 10a.

In the second embodiment, the flange 101 is disposed within the recess 43. This reliably prevents the coil spring 10a from falling out when the train bridge 4a is disposed. When the flange 101 is provided at the end of the coil spring 10a on the Z-direction upper side, unlike the first embodiment, the assembly sequence involves disposing the coil spring 10a on the Z-direction lower side of the center wheel bridge 6a, followed by placing the train bridge 4a over the coil spring 10a from the Z-direction lower side. It is difficult to dispose the coil spring 10a in the correct position with the coil spring 10a erected on a bare surface. However, in the embodiment, the guide shaft portion 51 protrudes from the main plate 5a in a region where the coil spring 10a is disposed. Therefore, by inserting the guide shaft portion 51 into the coil spring 10a, the coil spring 10a can be easily and stably erected. Consequently, in the second embodiment as well, the coil spring 10a can be stably disposed to contact both the center wheel bridge 6a and the circuit retainer 8, allowing static electricity flowing from a hand shaft 30 to the center wheel bridge 6a to be discharged to the circuit retainer 8. Furthermore, even when the back cover 12, circuit retainer 8, and buffer plate 9 are removed during repairs or other operations, the coil spring 10a does not accidentally fall out to the Z-direction upper side beyond the circuit board 7. This prevents the coil spring 10a from becoming mixed into the analog block 2.

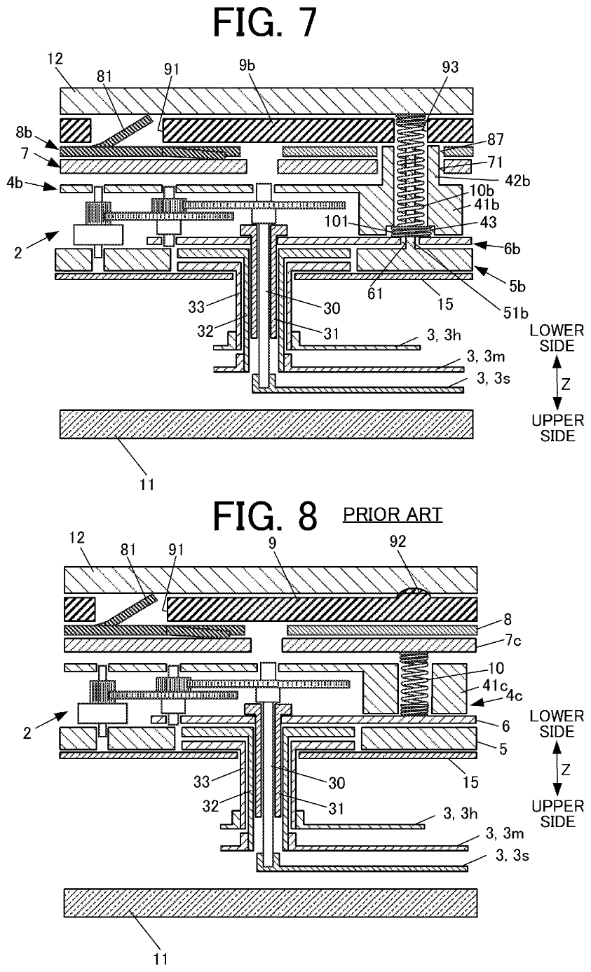

Next, in a timepiece according to the third embodiment, a back cover 12 functions as the first plate-shaped member formed of a conductive material, and a center wheel bridge 6b as the second plate-shaped member is electrically connected to the back cover 12 via a coil spring 10b as the connecting member. In this case, the length of the coil spring 10b in the Z-direction is set slightly longer than the distance from the center wheel bridge 6b to the back cover 12 in the Z-direction, enabling the coil spring 10b to reliably contact the center wheel bridge 6b and the back cover 12. As illustrated in FIG. 7, the coil spring 10b according to the embodiment is also a stepped coil spring, similar to the second embodiment, having a flange 101 formed at one end with a larger diameter than the spring body. The coil spring 10b is then erected along the Z-direction by inserting a guide shaft portion 51b into the coil spring 10b, and the coil spring 10b is disposed within a tubular support portion 41b with the flange 101 disposed within a recess 43 of a train bridge 4b. This prevents the coil spring 10b from slipping out of the train bridge 4b. In this embodiment as well, the tubular support portion 41b and guide shaft portion 51b constitute a support structure provided between the back cover 12 as the first plate-shaped member and the center wheel bridge 6b as the second plate-shaped member. The tubular support portion 41b and the guide shaft portion 51b as the support structure support the coil spring 10b as the connecting member in an upright state and maintain that upright state.

Furthermore, in the third embodiment, through holes 87 and 93 are formed in a circuit retainer 8b and a buffer plate 9b, respectively, at positions corresponding to the tubular support portion 41b (a smaller-diameter portion 42b of the tubular support portion 41b) and to a through hole 71. Moreover, as illustrated in FIG. 7, it is preferable to make the length of the guide shaft portion 51b in the Z-direction longer than that of the guide shaft portion 51 in the second embodiment (see FIG. 6) and make the length of the tubular support portion 41b in the Z-direction longer than that of the tubular support portion 41 in the first embodiment (see FIG. 2) and that of the tubular support portion 41a in the second embodiment, so that the coil spring 10b can be guided up to a location adjacent to the back cover 12. FIG. 7 illustrates an example where the guide shaft portion 51b and the tubular support portion 41b extend up to a location adjacent to the surface of the front side (upper side in the Z-direction) of the buffer plate 9b.

In the third embodiment, when assembling the module 1, the center wheel bridge 6b is disposed on the Z-direction lower side of a main plate 5b. In this step, the guide shaft portion 51b is inserted into a through hole 61. Then, the guide shaft portion 51b is inserted into the coil spring 10b, with the flange 101 facing the center wheel bridge 6b. Subsequently, the train bridge 4b is layered on the Z-direction lower side of the center wheel bridge 6b. In this step, the guide shaft portion 51b and the coil spring 10b are inserted into the tubular support portion 41b, and the flange 101 of the coil spring 10b is disposed within the recess 43. Furthermore, a circuit board 7 is disposed on the Z-direction lower side of the train bridge 4b. In this step, the tubular support portion 41b with the guide shaft portion 51b and coil spring 10b inserted is inserted into the through hole 71. Furthermore, the circuit retainer 8b is disposed on the Z-direction lower side of the circuit board 7. In this step, the tubular support portion 41b with the guide shaft portion 51b and coil spring 10b inserted is inserted into the through hole 87 of the circuit retainer 8b as well. Then, the buffer plate 9b is disposed on the Z-direction lower side of the circuit retainer 8b, and the coil spring 10b is inserted into the through hole 93 of the buffer plate 9b.

As illustrated in FIG. 7, the tubular support portion 41b (a smaller-diameter portion 42b of the tubular support portion 41b) and the guide shaft portion 51b according to the embodiment extend only up to a location adjacent to the surface of the Z-direction upper side of the buffer plate 9b, while the coil spring 10b extends to the Z-direction lower side of the lower surface of the buffer plate 9b. When a back cover 12 is attached to the case, the other end of the coil spring 10b contacts the back cover 12 on the front surface side (first side). This electrically connects the center wheel bridge 6b to the back cover 12 via the coil spring 10b. Consequently, in this third embodiment as well, static electricity flowing from a hand shaft 30 to the center wheel bridge 6b can be discharged to the back cover 12, which is the first plate-shaped member. Furthermore, even when the back cover 12, circuit retainer 8b, and buffer plate 9b are removed during repairs or other operations, the coil spring 10b does not accidentally fall out to the Z-direction upper side beyond the circuit board 7. This prevents the coil spring 10b from becoming mixed into the analog block 2.

In the conventional configuration illustrated in FIG. 8, a coil spring 10 as the connecting member contacts the surface of a circuit board 7c on the Z-direction upper side and is not inserted all the way to the Z-direction lower side of the circuit board 7c. Furthermore, a tubular support portion 41c of a train bridge 4c that holds the coil spring 10 upright is also formed only up to the Z-direction upper side of the circuit board 7c. As described earlier, the analog block 2 is provided on the Z-direction upper side of the circuit board 7c. When the entire coil spring 10 is disposed on the Z-direction upper side of the circuit board 7c, there is a high possibility that the coil spring 10 could become mixed into the analog block 2 if the coil spring 10 falls out due to vibration or impact during assembly, disassembly, or the like. In contrast, as in each of the above embodiments, when a portion of the coil spring 10 is inserted through to the Z-direction lower side of the circuit board 7, even if the back cover 12, circuit retainer 8, and buffer plate 9 are removed during repair or disassembly of the module 1 or the timepiece 100, the coil spring 10 does not accidentally fall out to the Z-direction upper side beyond the circuit board 7. This prevents the coil spring 10 from becoming mixed into the analog block 2.

As described above, the module 1 according to the present embodiment and the timepiece 100 that includes the module 1 include: the circuit retainer 8 (the back cover 12 in the third embodiment) serving as the first plate-shaped member that is formed of a conductive material; the center wheel bridge 6 serving as the second plate-shaped member that is formed of a conductive material and disposed on the first side (the Z-direction upper side) of the circuit retainer 8; the circuit board 7 disposed between the circuit retainer 8 (the first plate-shaped member) and the center wheel bridge 6 (the second plate-shaped member); the coil spring 10 serving as the connecting member that electrically connects the circuit retainer 8 (the first plate-shaped member) to the center wheel bridge 6 (the second plate-shaped member). The through hole 71 is formed in the circuit board 7. The coil spring 10 is inserted in the through hole 71 to electrically connect the circuit retainer 8 (the first plate-shaped member) to the center wheel bridge 6 (the second plate-shaped member).

A mechanism structure such as the analog block 2 is provided on the Z-direction upper side of the circuit board 7. When small components such as the coil spring 10 become mixed into the mechanism structure, they can cause various operational failures. In other words, the coil spring 10 and similar components to be installed within the timepiece are extremely small. They risk falling out from their designated positions due to slight vibrations or impacts, such as those caused by attaching or detaching surrounding components, and becoming mixed into the predetermined mechanism structure (e.g., the analog block 2). For example, the analog block 2 contains components such as a motor with a rotor magnet. Therefore, when the coil spring 10 falls out to the Z-direction upper side of the circuit board 7, the coil spring 10 may be attracted by the magnet and become mixed into the analog block 2, potentially causing operational failures in various components. In this regard, the embodiment features the coil spring 10 protruding to the Z-direction lower side (back surface side) beyond the circuit board 7. Consequently, even when the back cover 12, circuit retainer 8, and buffer plate 9 are removed during repairs or other operations, the coil spring 10 does not accidentally fall out to the Z-direction upper side (front surface side) beyond the circuit board 7. This prevents the coil spring 10 from becoming mixed into the mechanism structure such as the analog block 2.

Furthermore, the circuit retainer 8 or the back cover 12, which is the first plate-shaped member in the embodiment, has the GND potential, while the center wheel bridge 6 as the second plate-shaped member is disposed in an electrically floating state with respect to the GND potential. This allows static electricity that enters from the hand shaft 30 and flows to the center wheel bridge 6 to be discharged to the circuit retainer 8 or the back cover 12 functioning as the GND via the coil spring 10 as the connecting member.

Furthermore, in the module 1 and the timepiece 100 that includes the module 1, the third plate-shaped member formed of a non-conductive material may be disposed between the center wheel bridge 6 as the second plate-shaped member and the circuit board 7. In the embodiment, the third plate-shaped member is, for example, the train bridge 4. The train bridge 4 as the third plate-shaped member has the tubular support portion 41 that is erected along the penetration direction of the through hole 71 in the circuit board 7 at a position corresponding to the through hole 71 and supports the coil spring 10 as the connecting member. The coil spring 10 and at least a portion of the tubular support portion 41 (the smaller-diameter portion 42 in the embodiment) supporting the coil spring 10 are inserted in the through hole 71 in the circuit board 7. It is difficult to make the coil spring 10, which is the connecting member, stand upright on its own on a flat surface. Even if the coil spring 10 does stand upright on its own, being an extremely small component, the coil spring 10 is prone to falling over or shifting position due to vibrations or impacts during assembly of surrounding components. When the coil spring 10 falls over or moves during assembly, disassembly, or the like, it risks becoming mixed into the analog block 2, potentially causing equipment malfunctions or operational failures. In this regard, in the embodiment, the coil spring 10 is supported not only by the through hole 71 in the circuit board 7 but also by the tubular support portion 41 in the train bridge 4, enabling the coil spring 10 to stand upright stably. This prevents the coil spring 10 from falling out during assembly or other operations.

Furthermore, the coil spring 10, which is the connecting member, may have, as an outward flange for locking, the flange 101 in an end portion on the side facing the center wheel bridge 6 as the second plate-shaped member, as in the above-described second and third embodiments. In this case, the recess 43 is formed as a step portion in the tubular support portion 41 of the train bridge 4, which is the third plate-shaped member, to lock the flange 101. Consequently, when the train bridge 4 is layered onto the center wheel bridge 6 and the coil spring 10 is housed within the tubular support portion 41, the coil spring 10 will not detach regardless of the orientation in which the module 1 is tilted, thereby more reliably preventing the coil spring 10 from falling out.

Furthermore, the module 1 and the timepiece 100 that includes the module 1 may also include the fourth plate-shaped member on the opposite side of the center wheel bridge 6, which is the second plate-shaped member, from the side facing the circuit board 7. In the embodiment, the fourth plate-shaped member is the main plate 5. The main plate 5 as the fourth plate-shaped member may have the guide shaft portion 51 as a boss that is erected, corresponding to the disposed position of the coil spring 10 as the connecting member, along the penetration direction of the through hole 71 and inserted into the coil spring 10, as illustrated in the second and third embodiments, for example. In this case, in the center wheel bridge 6 as the second plate-shaped member that is disposed on the Z-direction lower side of the main plate 5, a second through hole (through hole 61) is formed at a position corresponding to the guide shaft portion 51. The guide shaft portion 51 is inserted in the second through hole. Thus, when the guide shaft portion 51 is provided as a boss, the upright state of the coil spring 10 can be supported more reliably.

Furthermore, in each of the above embodiments, the buffer plate 9, which is an elastic plate-shaped member, is disposed (layered) on the side opposite the first side (the Z-direction upper side) of the circuit retainer 8 as the first plate-shaped member. Furthermore, the buffer plate 9 according to the embodiment has the protrusion 92 at a position corresponding to the disposed position of the connecting member. This allows the circuit retainer 8 to be reliably pressed against and appropriately contacted with the coil spring 10, which is the connecting member.

Moreover, in the above embodiments, the first plate-shaped member is the circuit retainer 8 (in the first and second embodiments) or the back cover 12 (in the third embodiment). This allows components normally provided in the module 1 or timepiece 100 to be used as the GND, eliminating the need to add special components.

Furthermore, on the side opposite the first side (the Z-direction upper side) of the circuit retainer 8, the engraved portion 83 may be formed in which engraved marks such as various logos and part numbers are engraved. When the circuit retainer 8 is a relatively thin metal plate, forming the engraved portion 83 on one surface may cause the entire plate to warp toward the side of the surface on which the engraved portion 83 is formed. Particularly, as shown in the first and second embodiments, in the case where the first plate-shaped member is the circuit retainer 8, when the circuit retainer 8 warps toward the lower side in the Z-direction, the connectivity between the coil spring 10 and the circuit retainer 8 may deteriorate. Therefore, when the engraved portion 83 is formed on the surface of the side opposite the first side (the Z-direction upper side) of the circuit retainer 8, it is preferable to apply a stippling finish on the surface of the first side (the Z-direction upper side) of the circuit retainer 8. Specifically, for example, the stippled portion 85, stippled across the entire surface, is formed on the surface of the first side (the Z-direction upper side) of the circuit retainer 8. This results in the circuit retainer 8 having stippling (engraving) on the surfaces of both sides, counteracting and eliminating the warping. Consequently, connection failure with the coil spring 10 due to warping is prevented.

Although embodiments of the present invention are described above, the present invention is not limited to these embodiments and can be appropriately modified in a variety of aspects without departing from the scope of the present invention. For example, in the first and second embodiments, when applying a stippling finish to the circuit retainer 8, which is the first plate-shaped member, the region where the stippled portion 85 is formed need not cover the entire member as illustrated in FIG. 4. For example, the stippled portion 85 may be formed only in a region corresponding to, or adjacent to, the region where the engraved portion 83 is formed on the surface of the side opposite the first side (the Z-direction upper side), to counteract the effect of the engraved portion 83. Furthermore, end portions of the circuit retainer 8 are fixed to the circuit board with screws. Therefore, the end portions do not lift. For this reason, the stippling finish may be applied only to the central region not secured with screws. Furthermore, it is not essential to provide the engraved portion 83 on the surface of the side opposite the first side (the Z-direction upper side). Even when the engraved portion 83 is not provided, a stippling (engraving) finish may be applied only on the surface of the first side (the Z-direction upper side) to cause the circuit retainer 8 to warp toward the first side (upper side in the Z-direction), to ensure connectivity with the coil spring 10. Furthermore, the engraving finish (stippling finish in the embodiment) to be applied on the surface of the first side (the Z-direction upper side) may be applied especially around the region where the coil spring 10 is provided, which is a region where a warp toward the first side (upper side in the Z-direction) is desired to enhance connectivity with the coil spring 10. The type of stippling (engraving) used for the stippled portion 85 is not particularly limited. However, when the engraved portion 83 is formed on the surface of the Z-direction lower side of the circuit retainer 8, it is preferable to apply more stippling (engraving) on the surface of the first side (Z-direction upper side) than to the engraved portion 83.

Furthermore, as shown in the above embodiments, the length of the tubular support portion 41 supporting the coil spring 10 in its upright state is not limited to the illustrated examples. For example, the tubular support portion 41 may not be inserted in the through hole 71 of the circuit board 7, and only the coil spring 10 as the connecting member may be inserted in the through hole 71. In this case, the smaller-diameter portion 42 may not be provided in the tubular support portion 41. Furthermore, the tubular support portion 41 need only be capable of allowing the coil spring 10 to be inserted therein, and its size and shape are not limited to the illustrated examples. For example, the entire tubular support portion 41 may have a small diameter similar to that of the smaller-diameter portion 42. Alternatively, the diameter of the through hole 71 in the circuit board 7 may be increased to allow the entire tubular support portion 41, with its upper-side diameter maintained throughout its length in the Z-direction, to be inserted into the through hole 71. Furthermore, the length of the tubular support portion 41b in the Z-direction may be shorter than the example illustrated in FIG. 7. When shortening the length of the tubular support portion 41b, the diameters of the through holes 71 and 87 in the circuit board 7 and the circuit retainer 8b may be made smaller than the example illustrated in FIG. 7 (e.g., only slightly larger than the diameter of the coil spring 10b) to restrict the coil spring 10b by the through holes 71 and 87 so that the coil spring 10b does not move significantly within the through holes 71 and 87.

Furthermore, for example, as shown in the second and third embodiments, when the guide shaft portion 51 is erected as a boss extending from the main plate 5 into the coil spring 10, the length of the guide shaft portion 51 is not limited to the illustrated examples. For instance, the length of the guide shaft portion 51 in the Z-direction may be similar between the second and third embodiments. For example, even in the case of the second embodiment illustrated in FIG. 6, the coil spring 10 is guided by the guide shaft portion 51 up to the circuit board 7. Therefore, even when the coil spring 10 falls out, the coil spring 10 can be prevented from becoming mixed into the analog block 2 located on the Z-direction upper side of the circuit board 7. Furthermore, the guide shaft portion 51 need only support the coil spring 10 to stand upright on its own until the coil spring 10 is disposed within the tubular support portion 41, thereby positioning the coil spring 10. Provided the coil spring 10 does not buckle or collapse during this process, the guide shaft portion 51 may be shorter than shown in the illustrated example.

Furthermore, in the second and third embodiments, the case has been illustrated where the flange 101 is provided on each of the coil springs 10a and 10b to form a stepped coil spring, but the configuration of the coil spring is not limited thereto. For example, instead of the flange 101, an arm or the like capable of being hooked into the tubular support portion 41 of the train bridge 4 or the like may be provided in an end portion on the Z-direction upper side of the coil spring, allowing the coil spring to be locked into the tubular support portion 41 by a method other than disposing the flange within a recess.

Furthermore, in the second and third embodiments described above, the guide shaft portion 51 is erected protruding toward the lower side in the Z-direction from the main plate 5, and the guide shaft portion 51 is inserted into the coil spring 10 to guide the coil spring 10 to stand upright along the Z-direction. However, it is not essential to provide the guide shaft portion 51. For example, as long as the coil spring 10 can be made to stand upright on its own, such as by temporarily fixing the coil spring 10 to the surface of the center wheel bridge 6, the guide shaft portion 51 may not be provided. In this case, the train bridge 4, circuit board 7, circuit retainer 8, and the like are assembled while the coil spring 10 is temporarily fixed.

Furthermore, it is not essential to support the coil spring 10 using the train bridge 4 (the tubular support portion 41 of the train bridge 4) up to a position beyond the circuit board 7 on the lower side in the Z-direction. For example, even in a place where the tubular support portion 41 of the train bridge 4 cannot be provided, by forming through holes at corresponding positions in the center wheel bridge 6 and the circuit board 7 and erecting, from the main plate 5, a guide shaft portion 51 as illustrated in the second and third embodiments, the coil spring 10 as the connecting member can be supported between the center wheel bridge 6 and the first plate-shaped member (the circuit retainer 8 or the back cover 12). In this case as well, the coil spring 10 can electrically connect the circuit retainer 8 or the back cover 12 to the center wheel bridge 6.

Furthermore, for example, the tubular support portion 41 as in the first embodiment illustrated in FIG. 2 may be extended to the vicinity of the back cover 12 to allow the coil spring 10 to connect the center wheel bridge 6 to the back cover 12. In this case, through holes are formed at corresponding positions in respective components (namely, the circuit board 7, the circuit retainer 8, and the buffer plate 9) interposed between the center wheel bridge 6 and the back cover 12. The coil spring 10 and the tubular support portion 41 supporting the coil spring 10 are inserted in these through holes. Even with this configuration, the coil spring 10 will not fall out unless the back cover 12 is removed. Furthermore, even if the coil spring 10 does fall out, the coil spring 10 will not enter the upper side in the Z-direction beyond the circuit board 7. Therefore, the coil spring 10 can be prevented from becoming mixed into the analog block 2.

Furthermore, for example, in the above embodiments, the case where the module 1 is applied to the timepiece 100 has been illustrated, but the device to which the module 1 is applied is not limited to a timepiece. The module 1 may be used in any electronic device where malfunction may occur when external static electricity flows to precision electronic components mounted on a circuit board. For example, the configurations shown in the embodiments can be widely applied to various smartwatches, electronic devices that acquire biometric information such as heart rate and blood flow, and the like.

Although several embodiments of the present invention have been described above, the scope of the present invention is not limited to the above-described embodiments but includes the scope of the invention as described in the claims and the scope of equivalents thereof.

1. A timepiece comprising:
a first plate-shaped member formed of a conductive material;
a second plate-shaped member disposed on a first side of the first plate-shaped member and formed of a conductive material;
a circuit board disposed between the first plate-shaped member and the second plate-shaped member; and
a connecting member that electrically connects the first plate-shaped member to the second plate-shaped member, wherein
a through hole is formed in the circuit board, and
the connecting member is inserted in the through hole to electrically connect the first plate-shaped member to the second plate-shaped member.

2. The timepiece according to claim 1, wherein
the first plate-shaped member has a GND potential, and
the second plate-shaped member is disposed in an electrically floating state with respect to the GND potential.

3. The timepiece according to claim 1, further comprising a third plate-shaped member disposed between the second plate-shaped member and the circuit board and formed of a non-conductive material, wherein
the third plate-shaped member has a tubular support portion that is erected along a penetration direction of the through hole at a position corresponding to the through hole in the circuit board and supports the connecting member, and
the connecting member and at least a portion of the tubular support portion supporting the connecting member are inserted in the through hole in the circuit board.

4. The timepiece according to claim 3, wherein
the connecting member has an outward flange for locking, the outward flange being provided in an end portion on a side facing the second plate-shaped member, and
the tubular support portion has a step portion that locks the outward flange.

5. The timepiece according to claim 1, further comprising a fourth plate-shaped member on an opposite side of the second plate-shaped member from a side facing the circuit board, wherein
the fourth plate-shaped member has a boss that is erected, corresponding to a disposed position of the connecting member, along a penetration direction of the through hole and inserted in the connecting member, and
a second through hole is formed in the second plate-shaped member at a position corresponding to the boss.

6. The timepiece according to claim 1, further comprising an elastic plate-shaped member disposed on a side opposite the first side of the first plate-shaped member, wherein the elastic plate-shaped member has a protrusion at a position corresponding to a disposed position of the connecting member.

7. The timepiece according to claim 1, wherein the first plate-shaped member is a circuit retainer or a back cover.

8. The timepiece according to claim 1, wherein
the first plate-shaped member is a circuit retainer,
an engraved portion having an engraved mark is formed on a surface of a side opposite the first side of the first plate-shaped member, and
a stippling finish is applied on a surface of the first side of the first plate-shaped member.

9. The timepiece according to claim 1, further comprising a mechanism structure that includes a motor and a gear train mechanism and is disposed such that the circuit board is disposed between the first plate-shaped member and the mechanism structure.

10. The timepiece according to claim 1, wherein the connecting member is a coil spring.

11. The timepiece according to claim 1, further comprising a hand shaft, wherein
a hand is fixed to an end portion of the hand shaft, and
the second plate-shaped member is electrically connected to the hand shaft.

12. A module comprising:
a circuit retainer formed of a conductive material;
a second plate-shaped member disposed on a first side of the circuit retainer and formed of a conductive material;
a circuit board disposed between the circuit retainer and the second plate-shaped member; and
a connecting member that electrically connects the circuit retainer to the second plate-shaped member, wherein
a through hole is formed in the circuit board, and
the connecting member is inserted in the through hole to electrically connect the circuit retainer to the second plate-shaped member.

13. A method for manufacturing a timepiece, comprising:
disposing a second plate-shaped member formed of a conductive material;
disposing a circuit board on an upper side of the second plate-shaped member in a gravitational direction, a through hole being formed in the circuit board;
inserting a connecting member, in an upright state, into the through hole in the circuit board;
disposing a first plate-shaped member on an upper side of the circuit board in the gravitational direction, the first plate-shaped member being formed of a conductive material; and
electrically connecting the first plate-shaped member to the second plate-shaped member via the connecting member.

14. The method according to claim 13, further comprising providing a support structure that maintains the upright state of the connecting member and is disposed between the first plate-shaped member and the second plate-shaped member.
